(19) United States
(12) Patent Application Publication
(10) Pub. No.: US 2005/0048316 A1
(43) Pub. Date: Mar. 3, 2005

(54) Donor film for organic electroluminescent display device, method thereof, and organic electroluminescent display device using the same as donor film

(76) Inventors: Mu-Hyun Kim, Suwon-si (KR); Byung-Doo Chin, Suwon-si (KR); Min-Chul Suh, Suwon-si (KR); Nam-Choul Yang, Suwon-si (KR); Seong-Taek Lee, Suwon-si (KR)

Correspondence Address: Robert E. Bushnell, Suite 300, 1522 K Street, N.W., Washington, DC, 20005, US

(21) Appl. No.: 10/919,404

(22) Filed: Aug. 17, 2004

(30) Foreign Application Priority Data
Aug. 18, 2003 (KR) 2003-57034

(51) Int. Cl. H05B 33/12

(52) U.S. Cl. 428/690; 428/917; 428/332; 428/913; 428/914; 313/504; 313/506; 427/402; 156/272.2

(57) ABSTRACT

A donor film includes a base film, a light-to-heat conversion layer formed on the base film, and a transfer layer formed on the light-to-heat conversion layer, wherein the transfer layer is formed of at least two layers and its first layer adjacent to the base film is a polymeric material and its second layer above the polymeric material is a small molecular material. The donor film allows a polymeric material to be used as an upper layer in the organic layers constituting the full color organic EL display device when a lower layer of the organic layer is formed of a small molecular organic material. The donor film, a method for fabricating the donor film, and a full color organic EL display device fabricated using this donor film are provided. The EL display device according to the present invention has superior properties.

### CLAIM OF PRIORITY

This application claims all benefits accruing under 35 U.S.C. §119 from the Korean Patent Application No. 2003-57034 filed on Aug. 18, 2003, in the Korean Intellectual Property Office, the disclosure of which is incorporated herein in its entirety by reference.

### BACKGROUND OF THE INVENTION

1. Field of the Invention

The present invention relates to donor films for organic electroluminescent (EL) display devices, methods thereof, and organic EL display devices using the donor films and, more particularly, to donor films for full color organic EL display devices, methods for fabricating the same, and full color organic EL display devices using the donor films.

2. Description of the Related Art

In general, the organic EL display device is comprised of several layers such as an anode, a cathode, a hole injection layer, a hole transport layer, an emission layer, an electron transport layer, and an electron injection layer. The organic EL display device may be classified into polymeric and small molecular types based on materials to be used, and each layer may be formed by a vacuum deposition method in the case of a small molecular organic EL display device and by a spin coating method in the case of a polymeric EL display device, thereby forming the organic EL display device.

In the case of a single color display device, the organic EL display device using the polymer may be simply fabricated by the spin coating method. While it has a low driving voltage as compared to the small molecular type, it has a disadvantage that efficiency and lifetime are degraded. In addition, when a full color display device is fabricated, each of red, green, and blue color polymers should be patterned by an inkjet printing technique or a laser induced thermal imaging (LITI) technique, which causes luminous properties including efficiency and lifetime to be degraded.

In particular, when the patterning is carried out using the LITI technique, transfer cannot be made with a single polymeric material in most cases. A method for forming a pattern of a polymeric EL display device by means of the LITI technique is disclosed in Korean Patent Application No. 1998-51844, and is also disclosed in U.S. Pat. Nos. 5,998,085, 6,214,520, and 6,114,088, which are incorporated herein by reference.

In order to apply the LITI technique, a light source, a transfer film, and a substrate are at least required, and light emitted from the light source should be absorbed by a light absorbing layer of the transfer film, which needs to be converted to heat energy, and a transfer material of the transfer film should be transferred to the substrate by means of the heat energy to form a desired image. (See U.S. Pat. No. 5,220,348, 5,256,506, 5,278,023, and 5,308.737, which are incorporated herein by reference.)

The LITI technique can be used for fabricating a color filter for a liquid crystal display device, and also used for forming a pattern of a light emitting material. (See U.S. Pat. No. 5,998,085, which is incorporated herein by reference.)

U.S. Pat. No. 5,937,272 discloses a method for forming a high-definition patterned organic layer in a full color organic EL display device, wherein this method uses a donor support that is coated with a transferable organic EL material. The donor support is heated to cause the transfer of the organic EL material onto the recessed surface of the substrate forming the colored EL medium in the designated subpixels. In this case, the donor film is irradiated with light or heat to vaporize the light emitting material, which is transferred to the pixel.

U.S. Pat. No. 5,688,551 discloses a method for forming subpixels in each pixel area by transferring an organic EL medium from a donor sheet to a receiver sheet. In this case, the transfer process discloses a technique for forming subpixels by transferring sublimable organic EL media from a donor sheet to a receiver sheet at relatively low temperatures, typically less than about 400° C.

In recent years, small molecular and polymeric materials are often mixed to form an organic EL display device. In other words, a polymeric material is used for a hole transport layer and a small molecular material is used for an organic light emitting material so as to optimize properties of each layer, and vice versa.

The layer of the small molecular material is typically formed by a dry process such as vacuum deposition, and the layer of the polymeric material is formed by a wet process such as spin coating, inkjet printing, and the like.

When the polymeric material layer is formed by the wet process on the layer of the small molecular material by the wet process, the small molecular material is dissolved due to a solvent of the wet process. Accordingly, the polymeric material layers can be hardly formed on the small molecular material. This causes the structural limit of the organic EL display device.

In addition, the EL display device fabricated by the wet process has disadvantages of low luminous efficiency and high driving voltage.

### SUMMARY OF THE INVENTION

It is therefore an object of the present invention to provide an improved donor film for an organic electroluminescent (EL) display device.

It is also an object of the present invention to provide an improved method of fabricating a donor film for an organic electroluminescent device.

It is another object of the present invention to provide an improved organic EL display device.

It is further an object of the present invention to provide a donor film for a full color organic EL display device, a method thereof, and a full color organic EL display device using the donor film, which allows polymeric material to be used as an upper layer in organic layers constituting the full color organic EL display device when a lower layer of the organic layers is formed of a small molecular organic material.

In an exemplary embodiment of the present invention, a donor film for an organic EL display device includes: a base film; a light-to-heat conversion layer formed on the base film; and a transfer layer formed on the light-to-heat conversion layer, wherein the transfer layer is formed of at least two layers and its first layer adjacent to the base film is a polymeric material and its second layer above the polymeric material is a small molecular material.

In another exemplary embodiment of the present invention, a method for fabricating a donor film for an organic EL display device includes: providing a base film; forming a light-to-heat conversion layer on the base film; depositing a polymeric material as a first layer on the light-to-heat conversion layer by means of a wet process; and depositing a small molecular material as a second layer on the first layer by means of a dry process.

In yet another exemplary embodiment of the present invention, an organic EL display device includes: a substrate; a first electrode formed on the substrate; a first organic layer formed on the first electrode; a second organic layer formed on the first organic layer; and a second electrode formed on the second organic layer, wherein the first organic layer is formed of a small molecular organic material, and the second organic layer is formed of a polymeric material.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a diagram showing a transfer mechanism when an organic emission layer to be used in an organic EL display device is patterned to be transferred by means of a laser in accordance with the present invention;

FIG. 2 to FIG. 7 are cross-sectional views schematically showing a structure of a donor film for a full color organic EL display device in accordance with first to sixth embodiments of the present invention; and

FIG. 8 is a cross-sectional view schematically showing an organic EL display device fabricated by one embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

As stated above, the organic EL display device may be classified into polymeric and small molecular types based on materials to be used. The terms “polymer” and “small molecule” in this application refer to the compounds regarded as “polymer” and “small molecule,” respectively, in the field of the organic EL display device.

In this application, the terms “lower” and “upper” in the phrases “lower layer,” “lower position,” “upper layer,” and “upper position” in the structures of the organic EL display devices refer to the positions of the organic layers when the organic layers are stacked over the substrate.

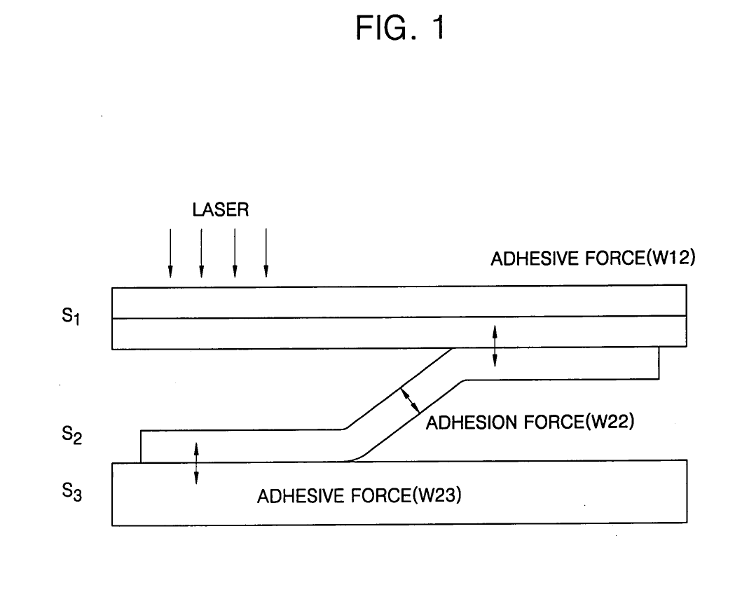

FIG. 1 is a diagram showing a transfer mechanism when an organic emission layer to be used in an organic EL display device is patterned to be transferred by means of a laser in accordance with the present invention.

A typical mechanism for transfer-patterning the organic layer using the laser requires that some portion of an organic layer S2 attached on a substrate S1 should be separated from the substrate S1 and transferred onto a substrate S3 by means of the laser while the rest of the organic layer S2 is not separated because it is not irradiated with the laser as shown in FIG. 1.

Major factors of determining transfer properties are a first adhesive force W₁₂ between the substrate S1 and the film S2, an adhesion force W₂₂ between films, and a second adhesive force W₂₃ between the film S2 and the substrate S3.

These first and second adhesive forces and the adhesion force may be represented by surface tensions (γ₁, γ₂, γ₃) and interface tensions (γ₁₂, γ₂₃) of each layer as denoted below.
W₁₂=γ₁+γ₂−γ₁₂
W₂₂=2 γ₂
W₂₃=γ₂+γ₃−γ₂₃

In order to enhance the transfer properties of the laser, the adhesion force between the films should be smaller than the adhesive force between each substrate and the film.

In general, since each layer of the organic EL display device is formed of an organic material, and the first and second adhesive forces are higher than the adhesion force in the case of the small molecular material, mass transition occurs such that a light emitting material is transferred from a donor film to the organic EL display device. This transfer leads to the fabrication of a fine pattern of the emission layer, and a possibility of causing miss-alignment may be reduced.

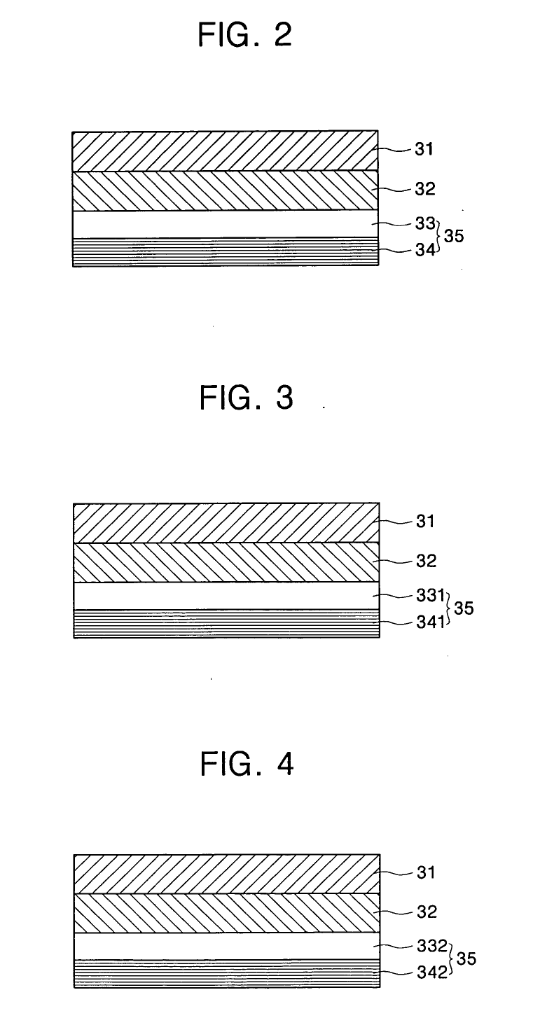

FIG. 2 is a cross-sectional view schematically showing a structure of a donor film for a full color organic EL display device in accordance with a first embodiment of the present invention.

As shown in FIG. 2, the donor film is composed of a base film 31, a light-to-heat (LTH) conversion layer 32, and a transfer layer 35.

The transfer layer 35 is formed of two or more layers in the first embodiment. A first layer 33 adjacent to the base film 31 is formed of a polymeric material, and a second layer 34 on the first layer 33 is formed of a small molecular material.

When the donor film for the organic EL display device is fabricated, the light-to-heat conversion layer 32 is typically formed on the base film 31 and the transfer layer 35 is formed on the light-to-heat conversion layer 32. A dry process is used to form the second layer 34 with the small molecular material, and a wet process is used to form the first layer 33 with the polymeric material.

However, if the transfer layer is formed of two or more layers as is described in the first embodiment of the present invention, and the first layer is composed of small molecular material, it is not easy to form the second layer of the polymeric material on the first layer. The reason is that the wet process is used for the polymeric material as previously mentioned so that a solvent to be used at this time dissolves the small molecular layer already formed as the transfer layer. This causes the properties of the small molecular layer to be changed.

Accordingly, the first layer 33 adjacent to the base film of the transfer layer 35 is formed of the polymeric material by means of the wet process, and the second layer 34 is formed of the small molecular material 34 to be stacked on the first layer 33 by means of the dry process such as deposition, thereby forming the transfer layer 35.

The thickness of the first layer is preferably 100 Å to 500 Å, and the thickness of the second layer is preferably 150 Å to 400 Å.

FIG. 2 shows the basic structure of the donor film, which may be modified in various ways. For example, an anti-reflection coating process may be carried out so as to prevent the properties of the transfer layer from being degraded due to the reflection, and a gas generating layer may be further formed below the light-to-heat conversion layer 32 so as to enhance sensitivity of the film.

The gas generating layer provides transfer energy by emitting nitrogen gas or hydrogen gas resulted from decomposition reaction when it absorbs light or heat. The gas generating layer is preferably formed of a material selected from pentaerythritol tetranitrate (PETN), trinitrotoluene (TNT), and so forth.

The base film 31 may be formed of transparent polymer, which includes polyester such as polyethylene terephthalate, polyacryl, polyepoxy, polyethylene, polystyrene, and the like. Among these examples, the polyethylene terephthalate film is mainly used. The thickness of the base film is preferably 10 μm to 500 μm. This base film acts as a support film, and multiple system may be used for the same.

The light-to-heat conversion layer 32 is formed of a light-absorbing material, which absorbs the light ranged from infrared rays to visible rays. The light-to-heat conversion layer 32 may be a metal layer formed of aluminum, its oxide, and sulfide, or a polymer organic layer containing carbon black, graphite, or infrared dye. If the metal layer is used, the preferred thickness is 100 Å A to 5,000 Å, and, if the polymer organic layer is used, the preferred thickness is 0.1 μm to 10 μm.

FIG. 3 to FIG. 7 are cross-sectional views schematically showing a structure of a donor film for a full color organic EL display device in accordance with second to sixth embodiments of the present invention.

As shown in FIG. 3, in the second embodiment of the present invention, a polymeric material constituting the first layer 33 of the transfer layer 35 is a polymeric light emitting material 331, and a small molecular material constituting the second layer 34 is a small molecular light emitting material 341.

Poly(9,9-dicoctyl fluorine) (PFO)-based polymer or poly(p-phenylene vinylene) (PPV)-based polymer may be used for the polymeric light emitting material 331.

It is preferable to use at least one of the compounds denoted below from Formula 1 to Formula 13 for the small molecular light emitting material 331.

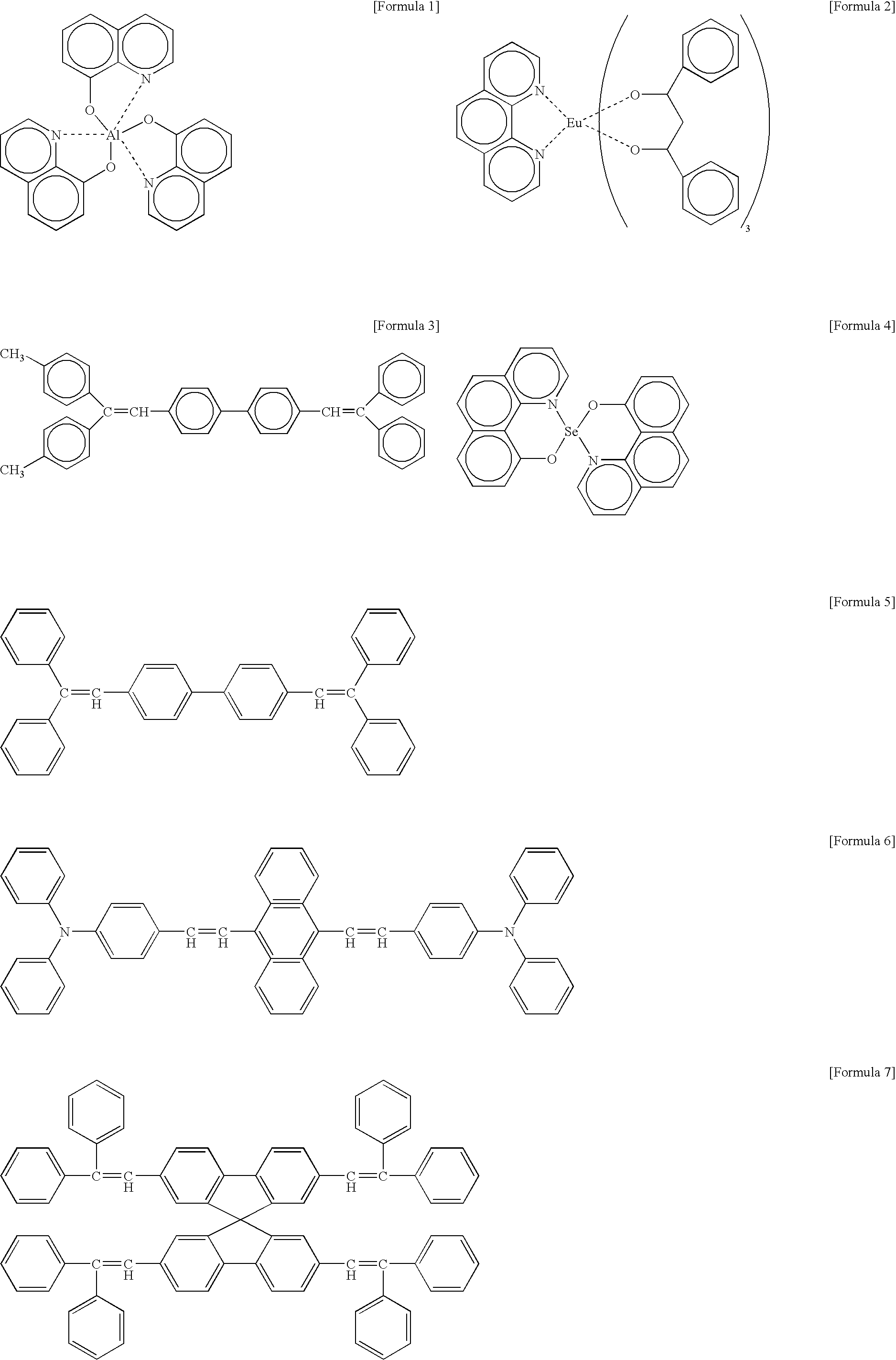

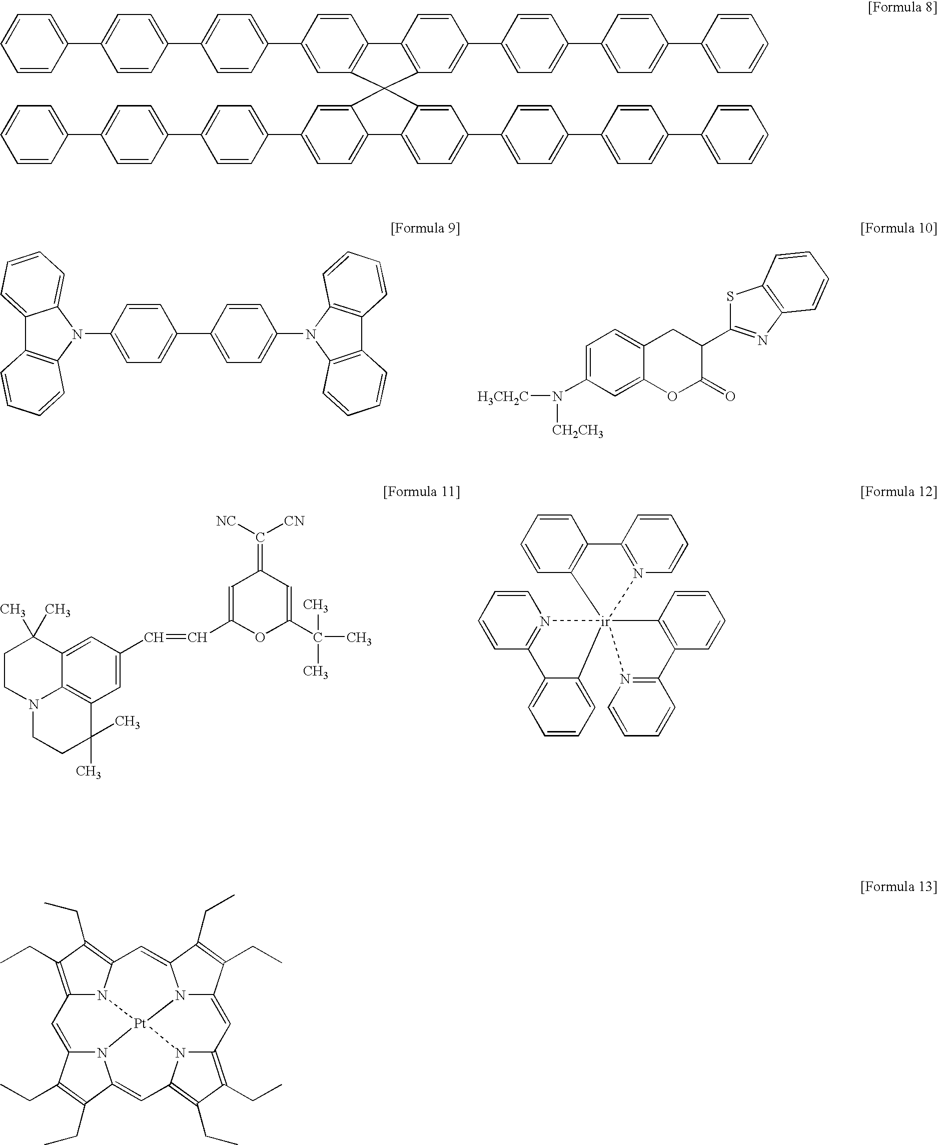

As shown in FIG. 4, in the third embodiment of the present invention, the polymeric material constituting the first layer 33 of the transfer layer 35 uses a polymeric electron transport material 332, and the small molecular material constituting the second layer 34 uses a small molecular light emitting material 342.

An oxadiazole-based polymer is preferably used for the polymeric electron transport material 332, and at least one of the materials listed as the small molecular light emitting material 341 used in the second embodiment is preferably used for the small molecular light emitting material 342.

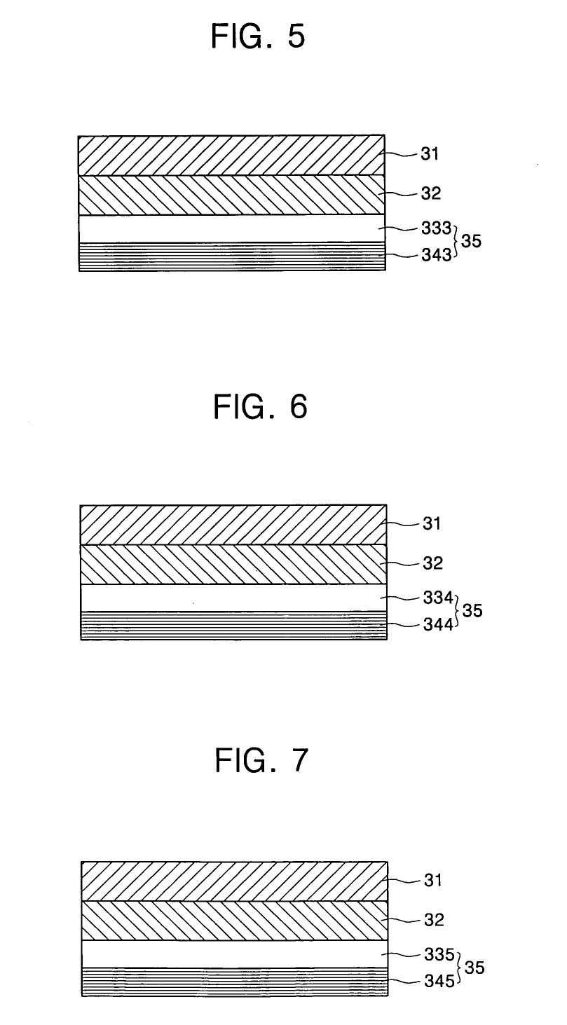

As shown in FIG. 5, in the fourth embodiment of the present invention, the polymeric material constituting the first layer 33 of the transfer layer 35 uses a polymeric hole transport material 333, and the small molecular material constituting the second layer 34 uses a small molecular light emitting material 343.

The polymeric hole transport material 333 is preferably formed of polyaniline (PANI), poly ethylene dioxy thiospnene (PEDOT), carbozole, arylamine, perylene, or pyrrole-based polymers, and at least one of the materials listed as the small molecular light emitting material 341 used in the second and third embodiments is preferably used for the small molecular light emitting material 343.

As shown in FIG. 6, in the fifth embodiment of the present invention, the polymeric material constituting the first layer 33 of the transfer layer 35 uses a polymeric light emitting material 334, and the small molecular material constituting the second layer 34 uses a small molecular hole transport material 344.

The material listed as the polymeric light emitting material 331 used in the second embodiment is preferably used for the polymeric light emitting material 334, and it is preferable to use one of the compounds represented by Formula 14 to Formula 21 for the small molecular hole transport material 344.

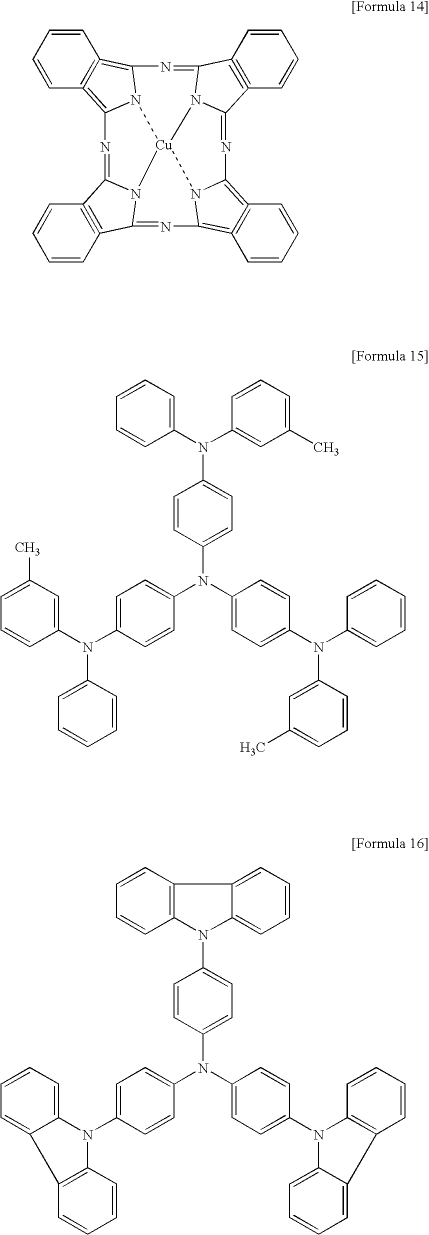

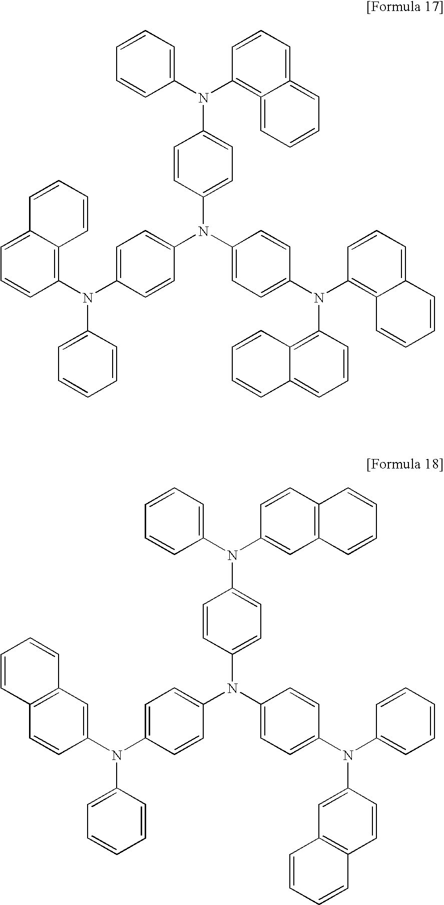

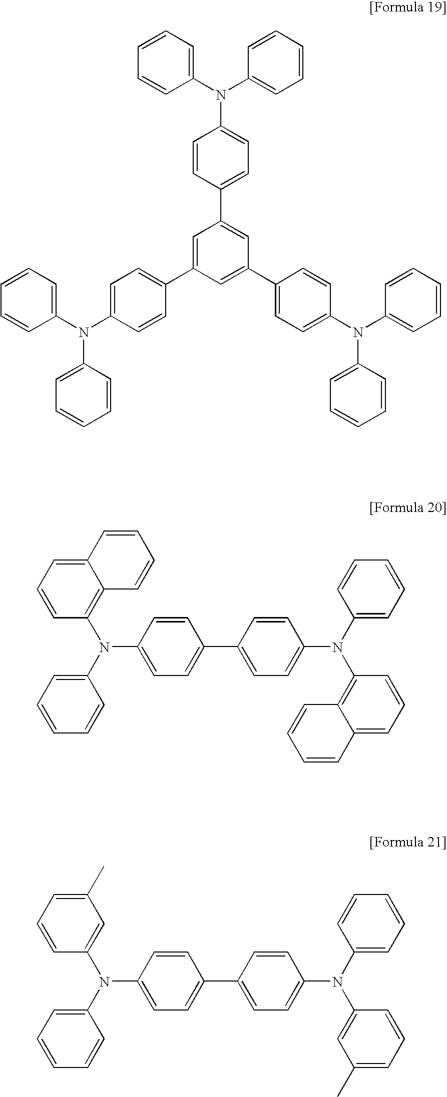

As shown in FIG. 7, in the sixth embodiment of the present invention, a polymeric material constituting the first layer 33 of the transfer layer 35 is a polymeric light emitting material 335, and a small molecular material constituting the second layer 34 is a small molecular electron transport material 345.

The materials listed as the polymeric light emitting materials 331 and 334 used in the second and fifth embodiments is preferably used for the polymeric light emitting material 335, and it is preferable to use a small molecular material such as bis(2-methyl-8-quinolinolato)(4-phenylphenolato)aluminum (BAlq), 2,9-dimethyl-4,7-diphenyl-1,10-phenanthroline (BCP), fluorocarbon (CFx), 3-phenyl-4-(1′-naphthyl)-5-phenyl-1,2,4-triazole (TAZ), s-TAZ, tris(8-quinolinolato)-aluminum (Alq3), Ga complex, 2-(4-biphenylyl)-5-(4-t-butylphenyl)-1,3,4-oxadiazole (PBD), 1,3,4-oxadizole derivative, or 1,2,4-traizole (TPA) for the small molecular electron transport material 345.

In the meantime, the transfer layer 35 of the donor film shown in FIG. 2 may further include one or more layers (hereinafter “third layer”) between the first layer 33 and the second layer 34.

In this case, a polymeric layer should not be formed on a small molecule layer already formed. In other words, when any one of the third layers between the first layer 33 and the second layer 34 is a small molecular layer, the second layer 34 should be formed on the small molecular layer. As previously mentioned, the reason is as follows. When a polymeric layer is formed on a small molecular layer, the polymeric material is deposited by, the wet process so that a solvent to be used in the wet process dissolves the small molecular layer which is already formed to cause the properties of the small molecular layer to be deteriorated. This is why the polymeric layer should not be formed on the small molecular layer.

The second layer 34 is an organic emission layer and/or a hole transport layer when the first layer 33 is an electron transport layer.

The second layer 34 is a hole transport layer or an electron transport layer when the first layer 33 is an organic emission layer.

In addition, the second layer 34 is preferably an organic emission layer and/or an electron transport layer when the first layer 33 is a hole transport layer.

Hereinafter, a method for fabricating the donor film having the configuration of the present invention will be described.

First, the light-to-heat conversion layer 32 is formed on the base film 31. The light-to-heat conversion layer 32 may be formed of a metal layer or an organic layer as previously described, and is formed by vacuum deposition, electron beam deposition, or sputtering to have a thickness of 100 Å to 5,000 Å in the case of the metal layer, and is formed by typical film coating methods such as extrusion, spin, gravure coating, web coating, dip coating, and knife coating to have a thickness of 0.1 μm to 10 μm.

When the light-to-heat conversion layer 32 is formed, a polymeric material is coated on the light-to-heat conversion layer 32 by the wet process, which is the first layer 33. Any one of the typical methods such as spin coating, inkjet printing, dipping, gravure coating, web coating, knife coating, and blade coating may be used for the wet process.

A small molecular material is then formed on the first layer 33 by the dry process, which is the second layer 34. Any one of vacuum deposition and sputtering may be used for the dry process.

When the polymeric material is formed of a polymeric light emitting material, the small molecular material may be formed of a small molecular light emitting material.

In addition, when the polymeric material is formed of an electron transport material, the small molecular material may be formed of a small molecular light emitting material.

In addition, when the polymeric material is formed of a hole transport material, the small molecular material may be formed of a small molecular light emitting material.

In addition, when the polymeric material is formed of a polymeric light emitting material, the small molecular material may be formed of a small molecular hole transport material.

In addition, when the polymeric material is formed of a polymeric light emitting material, the small molecular material may be formed of a small molecular electron transport material.

In the meantime, the thickness of the polymeric material is preferably 100 Å to 500 Å, and the thickness of the small molecular material is preferably 500 Å to 400 Å. The reason is as follows. When the full color organic EL display device is fabricated using the donor film of the present invention, the transfer layer 35 is transferred to the organic EL display device so that the organic layer is comprised of the first layer 33 and the second layer 34 with the thickness of the transfer layer 35. Thus, those thickness ranges are set to enable the device properties to be suitable for the full color organic EL display device.

In the meantime, the method for fabricating the donor film of the present invention may further include a step of forming one or more layers between the first layer 33 and the second layer 34.

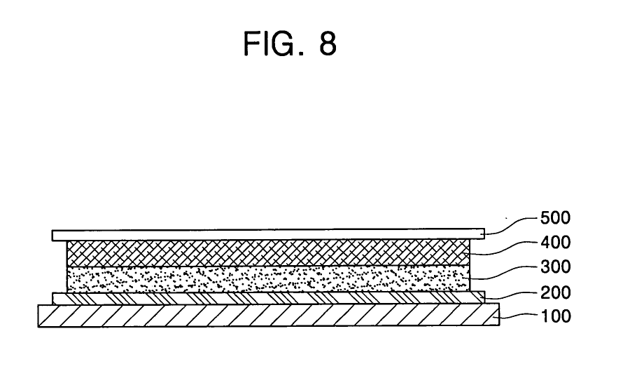

FIG. 8 is a cross-sectional view schematically showing a full color organic EL display device fabricated by one embodiment of the present invention.

Referring to FIG. 8, the full color organic EL display device of the present invention includes a substrate 100, a first electrode 200 formed on the substrate 100, a first organic layer 300 formed on the first electrode 200, a second organic layer 400 formed on the first organic layer 300, and a second electrode 500 formed on the second organic layer 400.

In this case, the first organic layer 300 is formed of a small molecular organic material, and the second organic layer 400 is formed of a polymeric material.

When the first electrode 200 is used as an anode that is a transparent electrode, the second electrode 500 becomes a cathode, and is formed of a metal electrode containing a reflective layer. This structure represents a bottom emitting full color EL display device.

The first electrode 200 may be an anode that uses a metal electrode containing a reflective layer, and the second electrode 500 may be a cathode that is a transparent electrode. This structure represents a top emitting full color EL display device.

In addition, the first electrode 200 may be a cathode that uses a metal electrode containing a reflective layer, and the second electrode 500 may be an anode that is a transparent electrode. This structure represents a top emitting inverted full color EL display device.

In the meantime, the first electrode 200 may be a cathode or anode which uses a metal electrode having a transparent electrode, and the second electrode 500 may be an anode or cathode that is a transparent electrode. This structure represents a double-sided full color organic EL display device.

The first organic layer 300 and the second organic layer 400 are sequentially formed on the first electrode 200, however, the first organic layer 300 is formed of the small molecular material, and the second organic layer 400 is formed of the polymeric material, so that a typical method does not facilitate the formation of the second organic layer 400 on the first organic layer 300.

Therefore, according to one embodiment of the present invention, the second organic layer 400 and the first organic layer 300 are stacked on the donor film as shown in FIG. 2 in this order, which are concurrently transferred onto a substrate of the organic EL display device by means of the LITI technique to thereby preferably form the first and second organic layers 300 and 400. The method for forming the donor film was described above, so that it will be omitted for simplicity of description.

Procedure of forming the first and second organic layers 300 and 400 resulted from the transfer layer 35 transferred onto the substrate is as follows.

First, the donor film is disposed at a position spaced apart from the first electrode layer 200 formed on the substrate 100, and an energy source is irradiated onto the donor film.

The energy source passes through the based film 31 by ways of a transfer device to activate the light-to-heat conversion layer 32 and to emit the heat due to light-to-heat conversion reaction. The donor film is expanded due to the emitted heat, thereby being closely adhered to the substrate, which leads to transfer of the transfer material onto the substrate 100 with desired pattern and thickness.

The energy source used for the present invention may include a laser, a Xe lamp, a flash lamp, and so forth. Among these examples, the laser is a preferable means to obtain the most superior transfer effect. In this case, all kinds of general-purpose lasers using solid, gas, semiconductor, dye, etc. are possible, and shapes of the laser beam may include a circular beam or other possible shapes.

The polymeric light emitting material may be used for the polymeric material constituting the second organic layer 400, and the small molecular light emitting material may be used for the small molecular organic material constituting the first organic layer 300.

A PFO-based polymer or a PPV-based polymer may be used for the polymeric light emitting material.

It is preferable to use at least one selected from the group denoted below from Formula 1 to Formula 13 for the small molecular light emitting material.

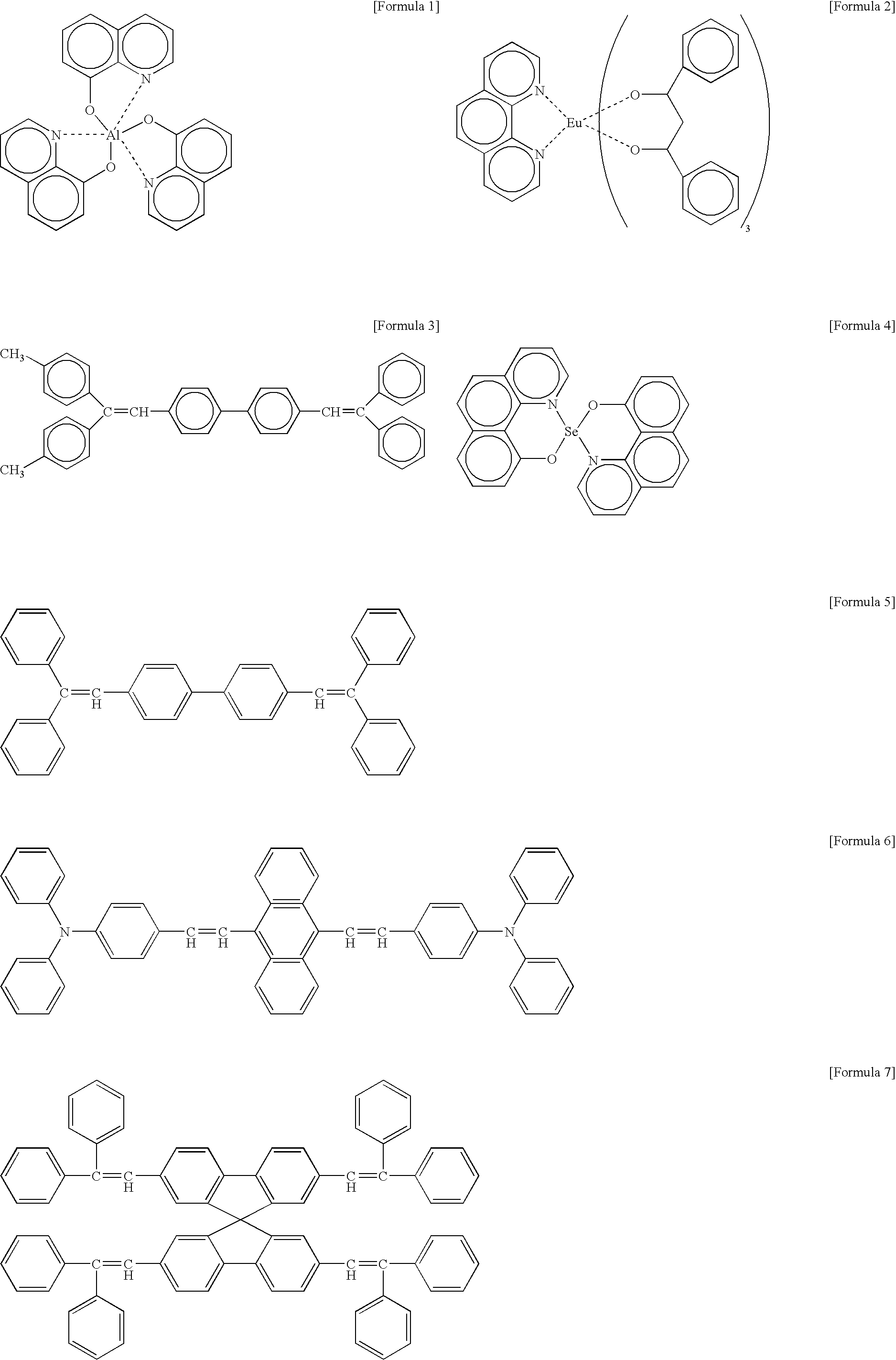

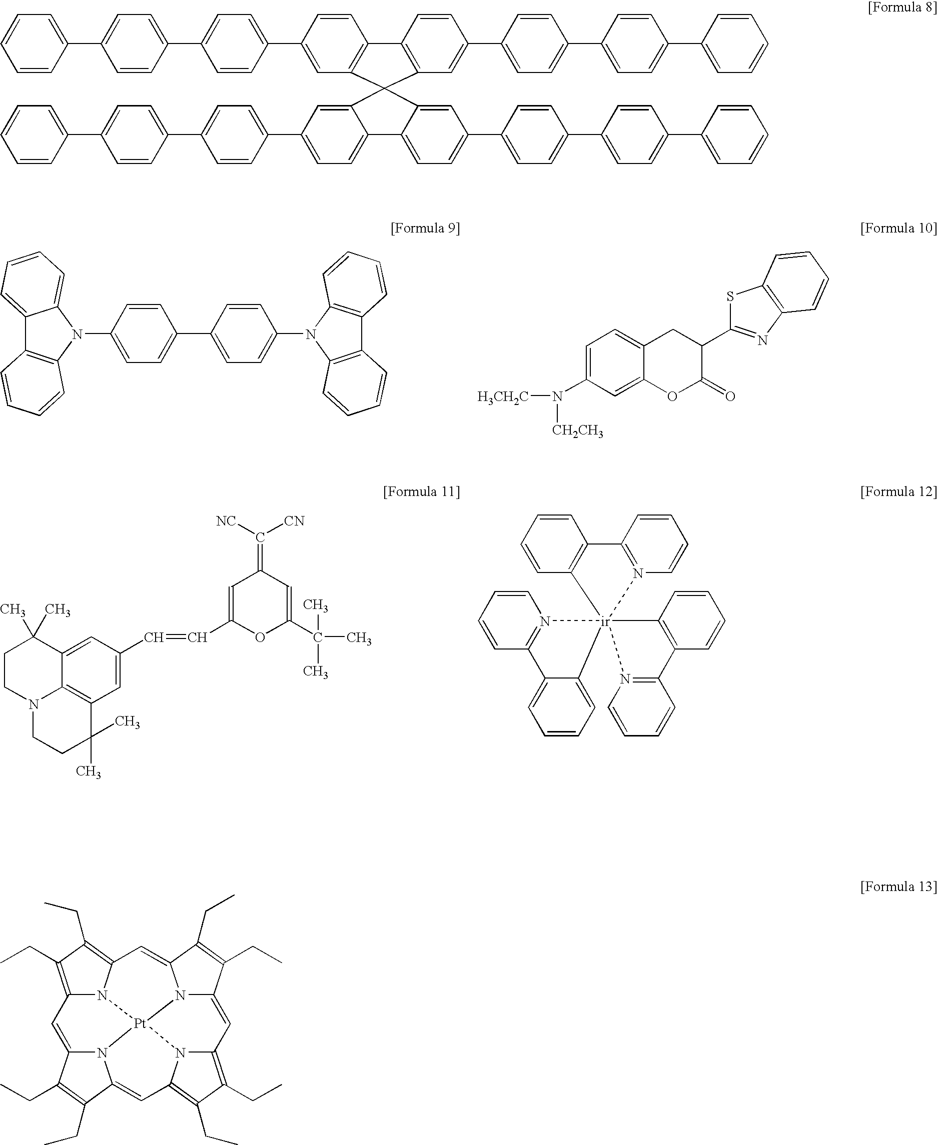

In addition, the polymeric electron transport material may be used for the polymeric material constituting the second organic layer 400, and the small molecular light emitting material may be used for the small molecular organic material constituting the first organic layer 300.

Oxadiazole-based polymer is preferably used for the polymeric electron transport material, and the same material as the small molecular light emitting material as previously described may be used for the small molecular light emitting material.

In addition, the polymeric hole transport material may be used for the polymeric material constituting the second organic layer 400, and the small molecular light emitting material may be used for the small molecular organic material constituting the first organic layer 300.

The polymeric hole transport material is preferably formed of one kind selected from a group consisting of PANI, PEDOT, carbozole, arylamine, perylene, and pyrrole-based polymers, and the same material as the small molecular light emitting material as previously described may be used for the small molecular light emitting material.

In addition, the polymeric light emitting material may be used for the polymeric material constituting the second organic layer 400, and the small molecular hole transport material may be used for the small molecular organic material constituting the first organic layer 300.

The same material as the polymeric light emitting material as previously described may be used for the polymeric light emitting material, and it is preferable to use one selected from the group denoted below from Formula 14 to Formula 21 for the small molecular hole transport material.

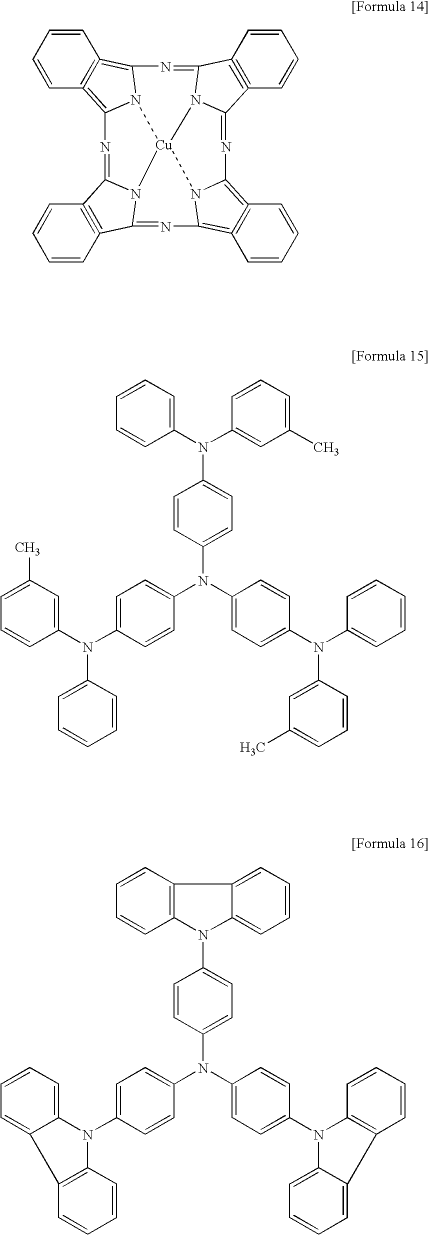

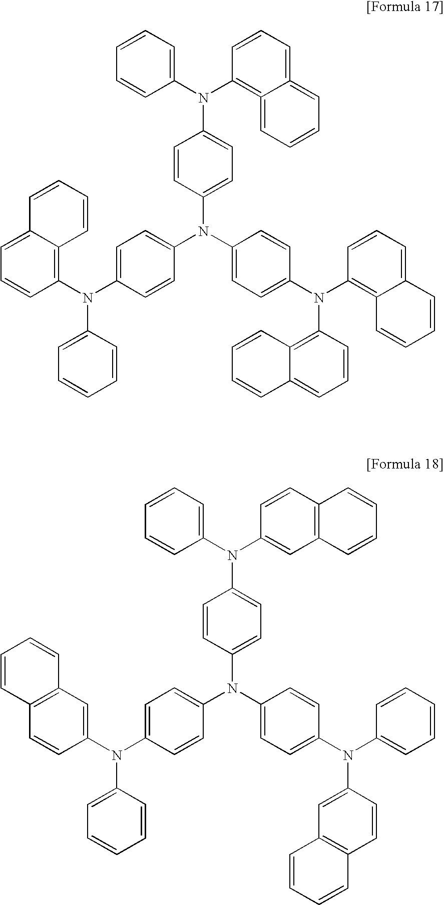

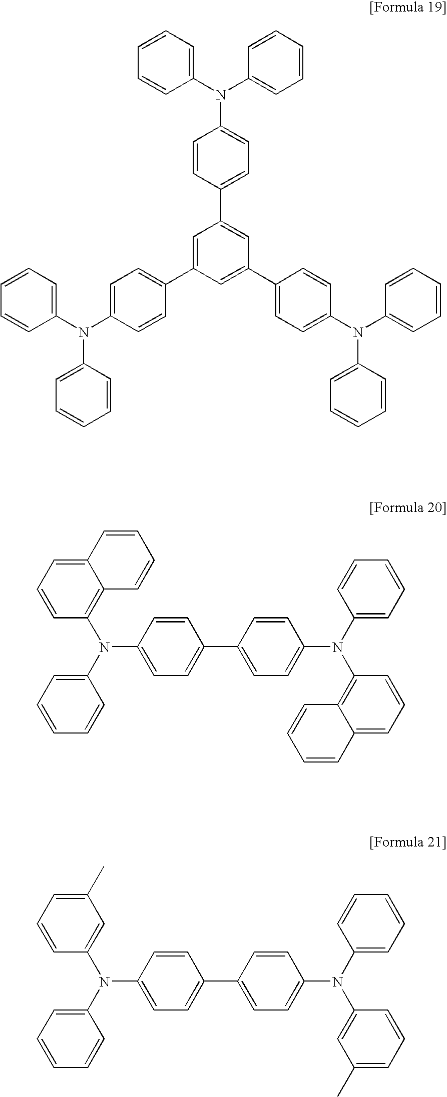

In addition, the polymeric light emitting material may be used for the polymeric material constituting the second organic layer 400, and the small molecular electron transport material may be used for the small molecular organic material constituting the first organic layer 300.

The same material as the polymeric light emitting material as previously described may be used for the polymeric light emitting material, and it is preferable to use one small molecule material selected from a group consisting of BAlq, BCP, CFx, TAZ, s-TAZ, Alq3, Ga complex, PBD, 1,3,4-oxadizole derivative, and 1,2,4-traizole (TPA) for the small molecular electron transport material.

The thickness of the first organic layer 300 is preferably 150 Å to 400 Å, and the thickness of the second organic layer 400 is preferably 100 Å to 500 Å, which leads to the implementation of the full color organic EL display device having superior properties.

In the meantime, the organic EL display device of the present invention may further include one or more third organic layers, and the third organic layer may be disposed between the first electrode 200 and the first organic layer 300, between the first organic layer 300 and the second organic layer 400, or between the second organic layer 400 and the second electrode 500, and is formed of at least one organic material.

A passivation layer is then encapsulated above the second electrode to keep the properties of the organic EL display device from external circumstances.

Hereinafter, preferred embodiments of the present invention will be described. However, these embodiments are only made for a purpose of illustrating the invention by way of examples, but not limited thereto.

### EXAMPLE 1

### Transfer Film/High Molecular EML/Small Molecular HTL

A method for fabricating the donor film in which a transfer layer is formed in accordance with the present invention is as follows.

On the donor film comprised of base film (100 μm)/light-to-heat conversion layer (4 μm)/interlayer (1 μm), a solution mixed with 1.0% polymeric blue light emitting solution (e.g., spiro-DPVBi from Covion Co.) and a solvent such as blue polymer (from Dow Chemical Co.) was spin-coated at a speed of 2,000 rpm to form a polymeric emission layer (EML) having a thickness of 300 Å, which becomes a first organic layer. The donor film coated with the polymeric emission layer was subject to thermal treatment at a temperature of 80° C. for 30 minutes to remove the solvent, and it was moved into an organic deposition chamber and deposited with a small molecular hole transport layer (HTL) (e.g., Idemitsu 320 from Idemitsu Kosan Co., Ltd.) having a thickness of 300 Å, thereby forming the second organic layer.

In the meantime, a method for fabricating the organic EL display device in accordance with the present invention is as follows.

Indium-Tin-Oxide (ITO) substrate was subject to a cleaning treatment, and a subsequent UV-O₃ treatment for 15 minutes, and it was deposited with a hole injection layer having a thickness of 600 Å (e.g., IDE406 from Idemitsu Kosan Co., Ltd.) as a third organic layer, thereby forming a lower substrate.

The above-mentioned donor film stacked with the polymeric and small molecular organic layers were positioned over the ITO substrate, and the stacked layers were transferred onto the substrate by means of the laser. After a hole injection layer, a small molecular hole transport layer, and a polymeric emission layer were formed on the ITO substrate, a small molecular electron transport layer (e.g., Alq3 from Nippon Steel Chemical Co.) having a thickness of 200 Å as another third organic layer was also stacked thereon by means of deposition to complete the organic layer. 1 nm thick LiF and 300 nm thick Al were sequentially deposited for the cathode and a glass substrate was encapsulated thereon, thereby completing the device. A blue device fabricated by the above-mentioned process represented a luminance of 200 Cd/m² and an efficiency of 3Cd/A, color coordinates of 0.15, 0.20 at a driving voltage of 5V, and a lifetime of 2,000 hours at an initial luminance of 200 Cd/m².

### COMPARATIVE EXAMPLE

### Transfer Film/High Molecular EML

The same method as the above-mentioned example was used except that only the polymeric EML was coated on the transfer film to fabricate the device without having the small molecular hole transport layer (HTL).

An indium-tin-oxide (ITO) substrate was subject to a cleaning treatment, and a subsequent UV-O₃ treatment for 15 minutes, and it was deposited with a hole injection layer having a thickness of 600 Å (e.g., IDE406 from Idemitsu Kosan Co., Ltd.) as a third organic layer, thereby forming a lower substrate. The transfer film coated only with the polymeric layer was positioned over the ITO substrate, and the stacked layers were transferred onto the substrate by means of the laser. After a hole injection layer and a polymeric emission layer were formed on the ITO substrate, a small molecular electron transport layer (e.g., Alq3 from Nippon Steel Chemical Co.) having a thickness of 200 Å as another third organic layer was also stacked thereon by means of deposition to thereby complete the organic layer. 1 m thick LiF and 300 nm thick Al were sequentially deposited for the cathode and a glass substrate was encapsulated thereon, thereby completing the device. A blue device fabricated by the above-mentioned process represented a luminance of 200 Cd/m² and an efficiency of 2.5 Cd/A, color coordinates of 0.15, 0.20 at a driving voltage of 5 V, and a lifetime of 300 hours at an initial luminance of 200 Cd/m².

As mentioned above, by means of the donor film according to the present invention, an organic EL display device may be implemented, which is comprised of its lower portion formed of a small molecular organic material and its upper portion formed of a polymeric material, so that a structure suitable for the device properties and a material to be used are not restricted, thereby providing the organic EL display device having superior properties.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. A donor film for an organic electroluminescent display device, comprising:
a base film;
a light-to-heat conversion layer formed on the base film; and
a transfer layer formed on the light-to-heat conversion layer, the transfer layer comprising at least two layers which include a first layer adjacent to the base film and a second layer over the first layer, said first layer formed of polymeric material, said second layer formed of small molecular material.

2. The donor film according to claim 1, wherein the polymeric material is a polymeric light emitting material, and the small molecular material is a small molecular light emitting material.

3. The donor film according to claim 1, wherein the polymeric material is an electron transport material, and the small molecular material is a small molecular light emitting material.

4. The donor film according to claim 3, wherein the electron transport material is an oxadiazole-based polymeric material.

5. The donor film according to claim 3, wherein the small molecular light emitting material is at least one selected from the group consisting of Formulas 1 to 13:

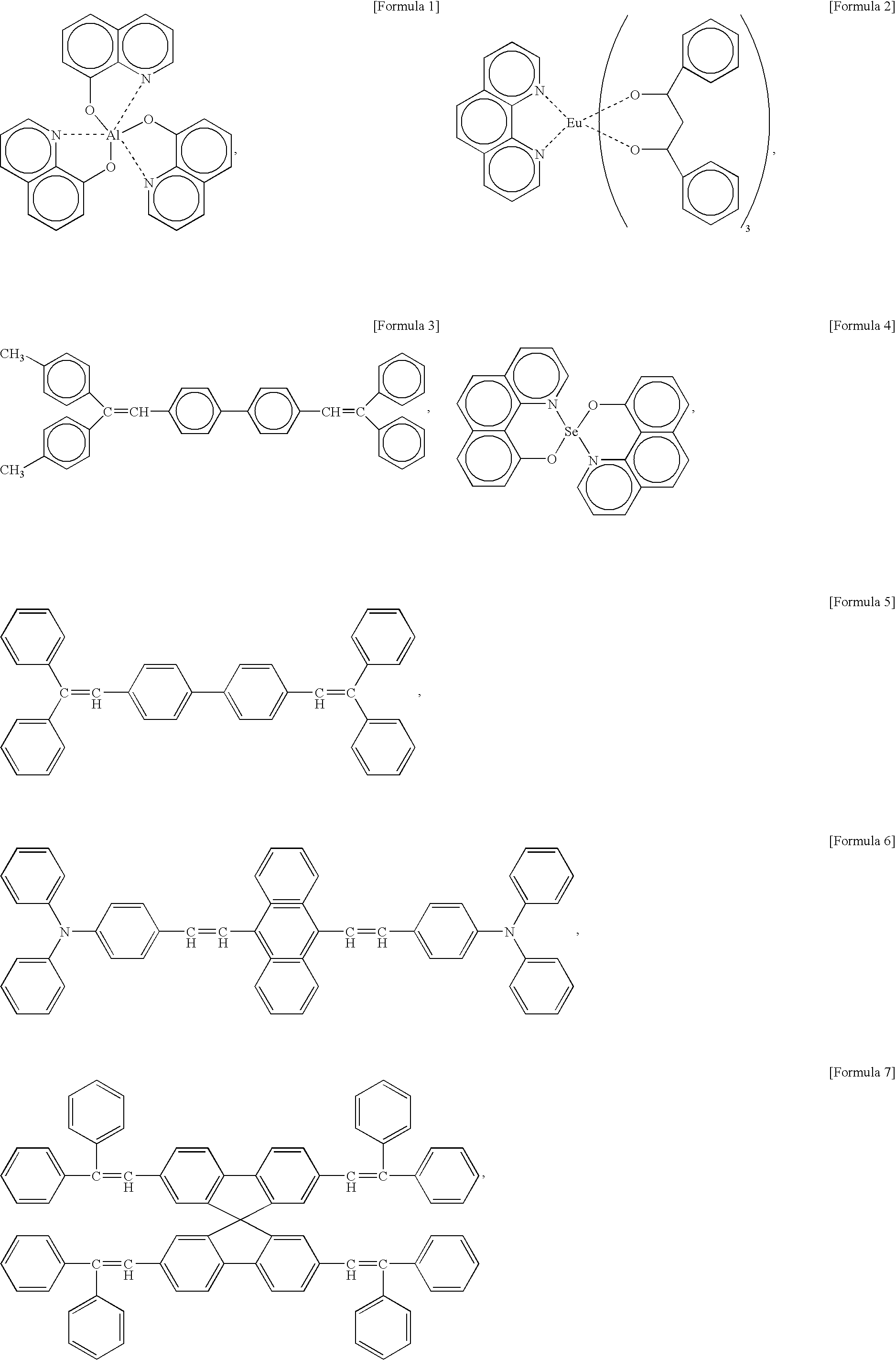

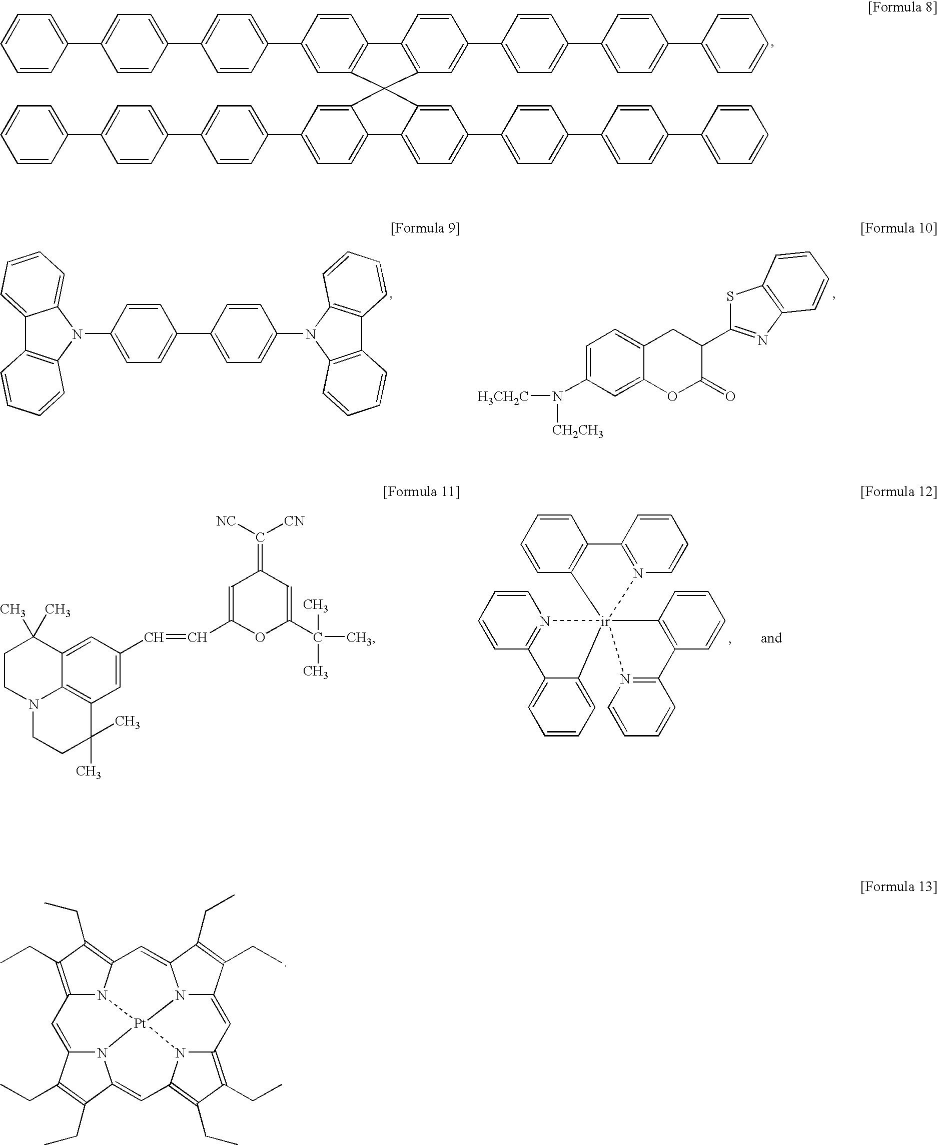

6. The donor film according to claim 1, wherein the polymeric material is a hole transport material, and the small molecular material is a small molecular light emitting material.

7. The donor film according to claim 6, wherein the hole transport material is selected from the group consisting of polyaniline (PANI), poly ethylene dioxy thiospnene (PEDOT), carbozole, arylamine, perylene, and pyrrole-based polymers.

8. The donor film according to claim 6, wherein the small molecular light emitting material is at least one selected from the group consisting of Formulas 1 to 13:

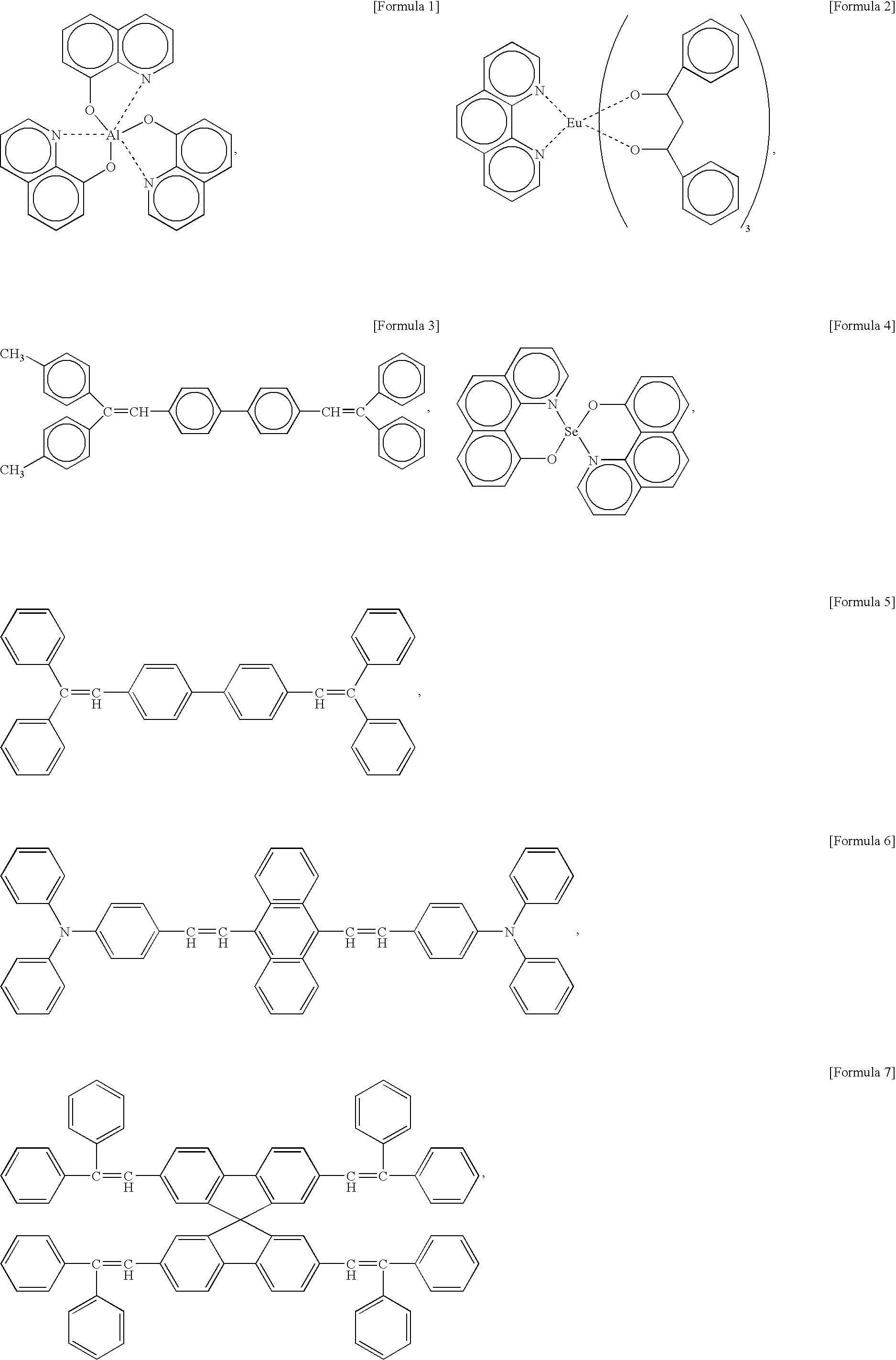

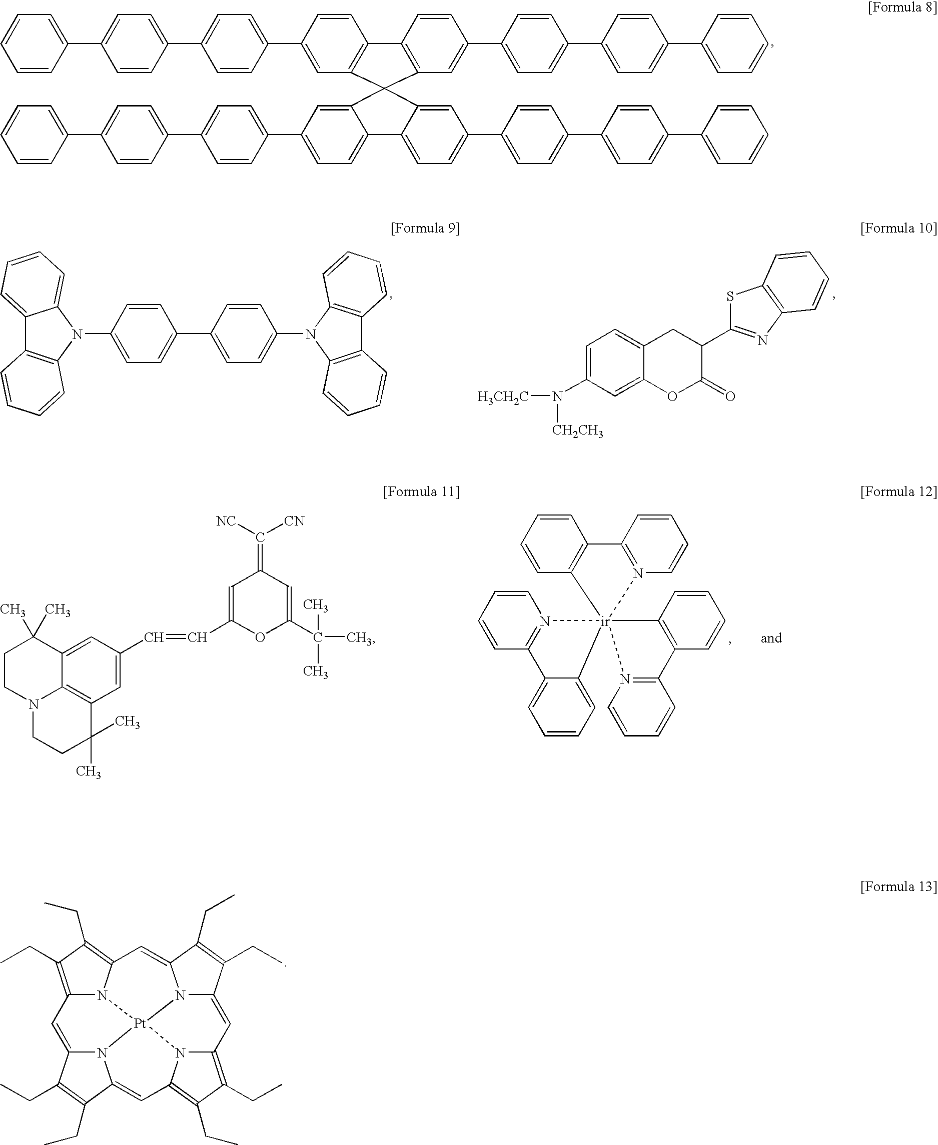

9. The donor film according to claim 1, wherein the polymeric material is a polymeric light emitting material, and the small molecular material is a small molecular hole transport material.

10. The donor film according to claim 9, wherein the polymeric light emitting material is one of poly(9,9-dicoctyl fluorine)-based polymers and poly(p-phenylene vinylene)-based polymers.

11. The donor film according to claim 9, wherein the small molecular hole transport material is at least one selected from the group consisting of Formulas 14 to 21:

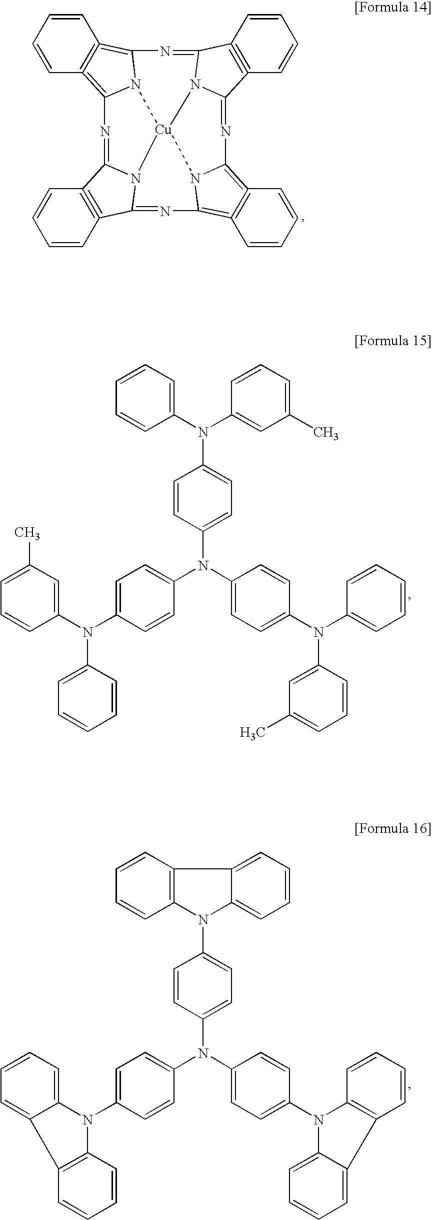

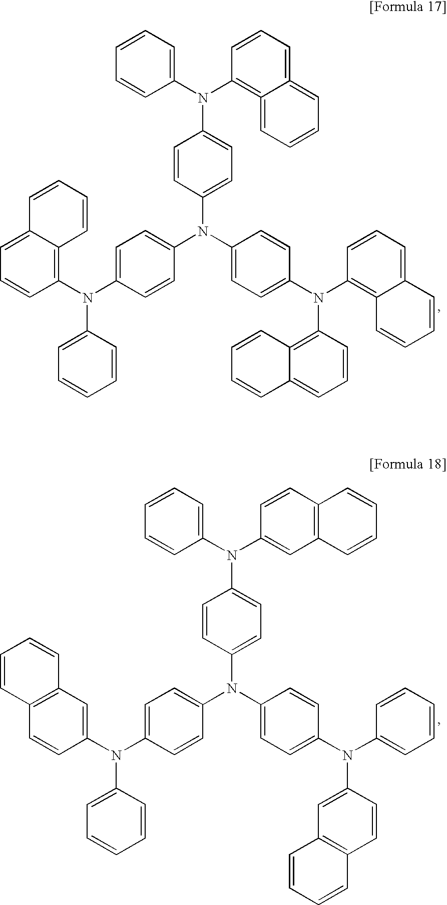

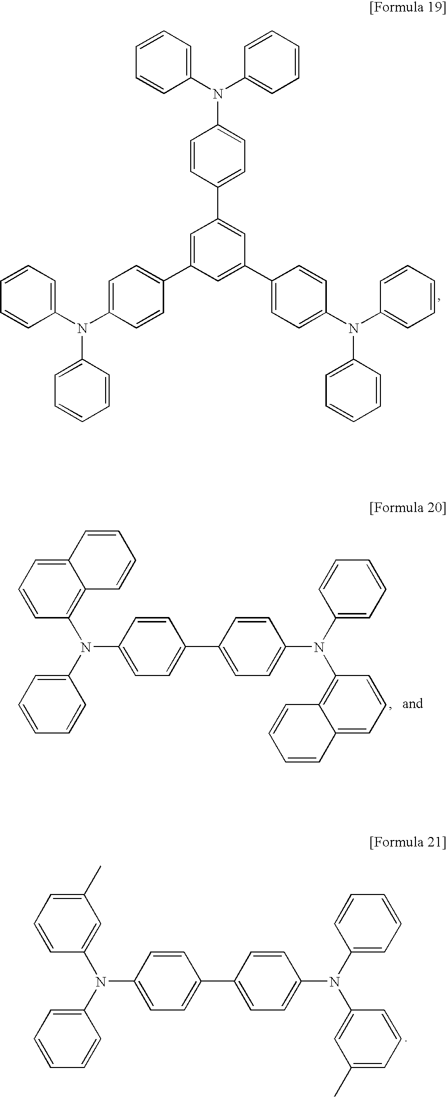

12. The donor film according to claim 1, wherein the polymeric material is a polymeric light emitting material, and the small molecular material is a small molecular electron transport material.

13. The donor film according to claim 12, wherein the polymeric light emitting material is one of Poly(9,9-dicoctyl fluorine)-based polymers and poly(p-phenylene vinylene)-based polymers.

14. The donor film according to claim 12, wherein the small molecular electron transport material is one small molecule selected from a group consisting of bis(2-methyl-8-quinolinolato)(4-phenylphenolato)aluminum (BAlq), 2,9-dimethyl-4,7-diphenyl-1,10-phenanthroline (BCP), fluorocarbon (CFx), 3-phenyl-4-(1′-naphthyl)-5-phenyl-1,2,4-triazole (TAZ), s-TAZ, tris(8-quinolinolato)-aluminum (Alq3), Ga complex, 2-(4-biphenylyl)-5-(4-t-butylphenyl)-1,3,4-oxadiazole (PBD), 1,3,4-oxadizole derivative, or 1,2,4-traizole (TPA).

15. The donor film according to claim 1, wherein the polymeric material has a thickness of about 100 Å to 500 Å, and the small molecular material has a thickness of about 150 Å to 400 Å.

16. The donor film according to claim 1, wherein the transfer layer further includes at least one third layer between the first layer and the second layer.

17. The donor film according to claim 16, wherein, when said third layer includes a small molecular layer, the second layer is formed on the small molecular layer of said third layer.

18. The donor film according to claim 17, wherein the second layer is one of an organic emission layer and a hole transport layer when the first layer is an electron transport layer.

19. The donor film according to claim 17, wherein the second layer is one of a hole transport layer and an electron transport layer when the first layer is an organic emission layer.

20. The donor film according to claim 17, wherein the second layer is one of an organic emission layer and an electron transport layer when the first layer is a hole transport layer.

21. The donor film according to claim 1, wherein the light-to-heat conversion layer is formed of a light absorbing material that absorbs infrared light or visible light.

22. The donor film according to claim 1, wherein the base film is formed of transparent polymer, and the transparent polymer is selected from the group consisting of polyester, polyacryl, polyepoxy, polyethylene, polypropylene, and polystyrene.

23. The donor film according to claim 1, further comprising a gas generating layer on the light-to-heat conversion layer.

24. A method of transferring organic layers to the organic electroluminescent display device, comprises utilizing the donor film of claim 1.

25. A method for fabricating a donor film for an organic EL display device, comprising:
providing a base film;
forming a light-to-heat conversion layer on the base film;
depositing a polymeric material to form a first layer on the light-to-heat conversion layer by a wet process; and
depositing a small molecular material to form a second layer on the first layer by a dry process.

26. The method according to claim 25, wherein the wet process is selected from the group consisting of spin coating, inkjet printing, dipping, gravure coating, web coating, knife coating and blade coating, and the dry process is selected from the group consisting of vacuum deposition and sputtering.

27. The method according to claim 25, wherein the polymeric material is a polymeric light emitting material, and the small molecular material is a small molecular light emitting material.

28. The method according to claim 25, wherein the polymeric material is an electron transport material, and the small molecular material is a small molecular light emitting material.

29. The method according to claim 25, wherein the polymeric material is a hole transport material, and the small molecular material is a small molecular light emitting material.

30. The method according to claim 25, wherein the polymeric material is a polymeric light emitting material, and the small molecular material is a small molecular hole transport material.

31. The method according to claim 25, wherein the polymeric material is a polymeric light emitting material, and the small molecular material is a small molecular electron transport material.

32. The method according to claim 25, wherein the polymeric material has a thickness of about 100 Å to 500 Å, and the small molecular material has a thickness of about 150 Å to 400 Å.

33. The method according to claim 25, further comprising:
forming at least one third layer between the first layer and the second layer of the transfer layer.

34. The method according to claim 33, wherein when said third layer includes a small molecular layer, the second layer is formed on the small molecular layer of said third layer.

35. The method according to claim 25, further comprising:
an anti-reflection coating process to prevent the properties of the transfer layer from being degraded due to the reflection.

36. The donor film produced by the method of claim 25.

37. An organic EL display device, comprising:
a substrate;
a first electrode formed on the substrate;
a first organic layer formed over the first electrode, said first organic layer formed of a small molecule material;
a second organic layer formed over the first organic layer, said second organic layer formed of a polymeric material; and
a second electrode formed over the second organic layer.

38. The organic EL display device according to claim 37, wherein at least one of the first electrode and the second electrode is a cathode, and the other is an anode.

39. The organic EL display device according to claim 37, wherein the first organic layer and the second organic layer are formed by concurrently transferring the second organic layer and the first organic layer stacked a donor film onto the substrate by a laser induced thermal imaging (LITI) technique.

40. The organic EL display device according to claim 37, wherein the polymeric material is a polymeric light emitting material, and the small molecular organic material is a small molecular light emitting material.

41. The organic EL display device according to claim 37, wherein the polymeric material is an electron transport material, and the small molecular organic material is a small molecular light emitting material.

42. The organic EL display device according to claim 41, wherein the electron transport material is an oxadiazole-based high molecule.

43. The organic EL display device according to claim 41, wherein the small molecular light emitting material is at least one selected from the group consisting of Formulas 1 to 13:

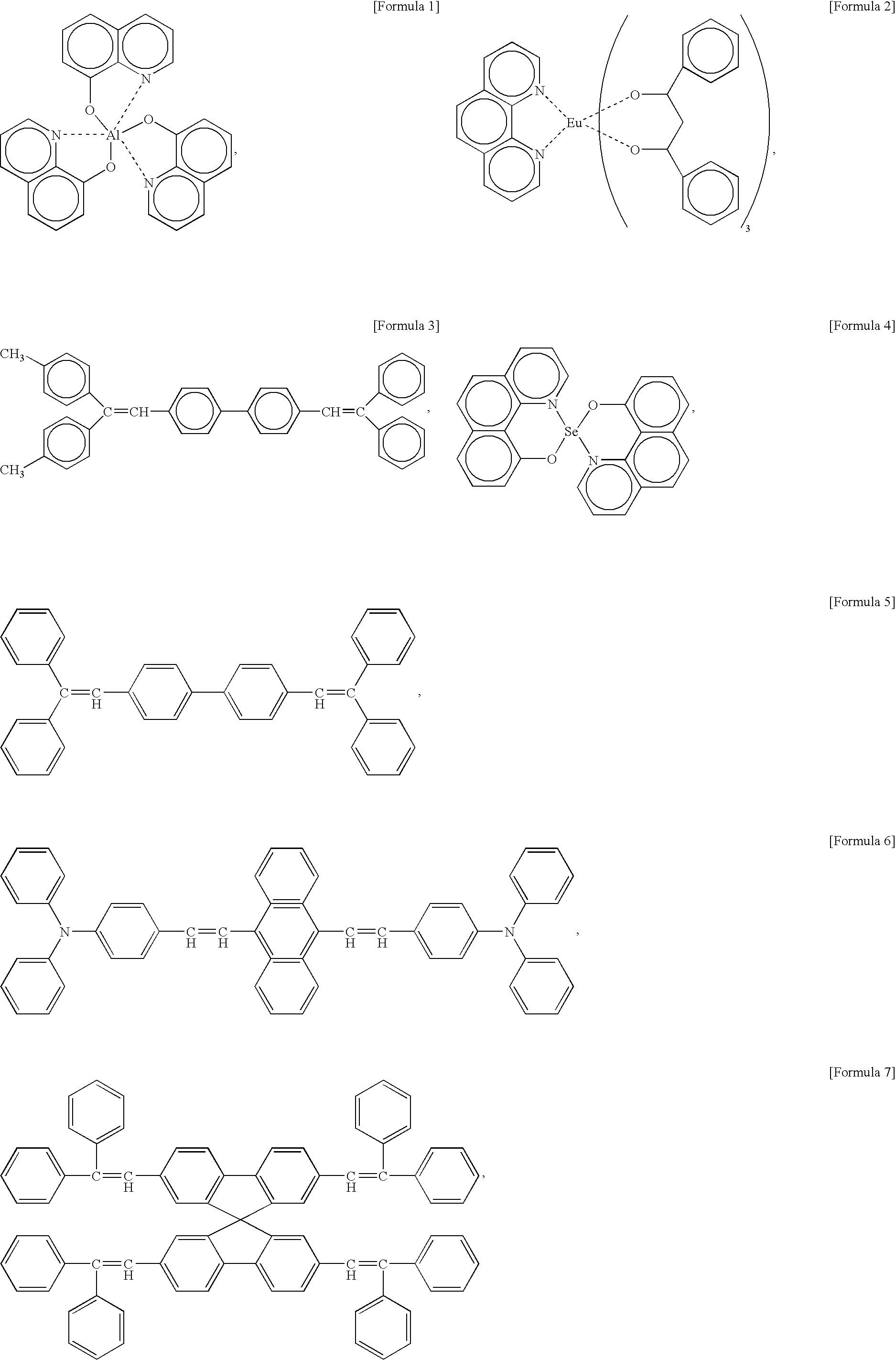

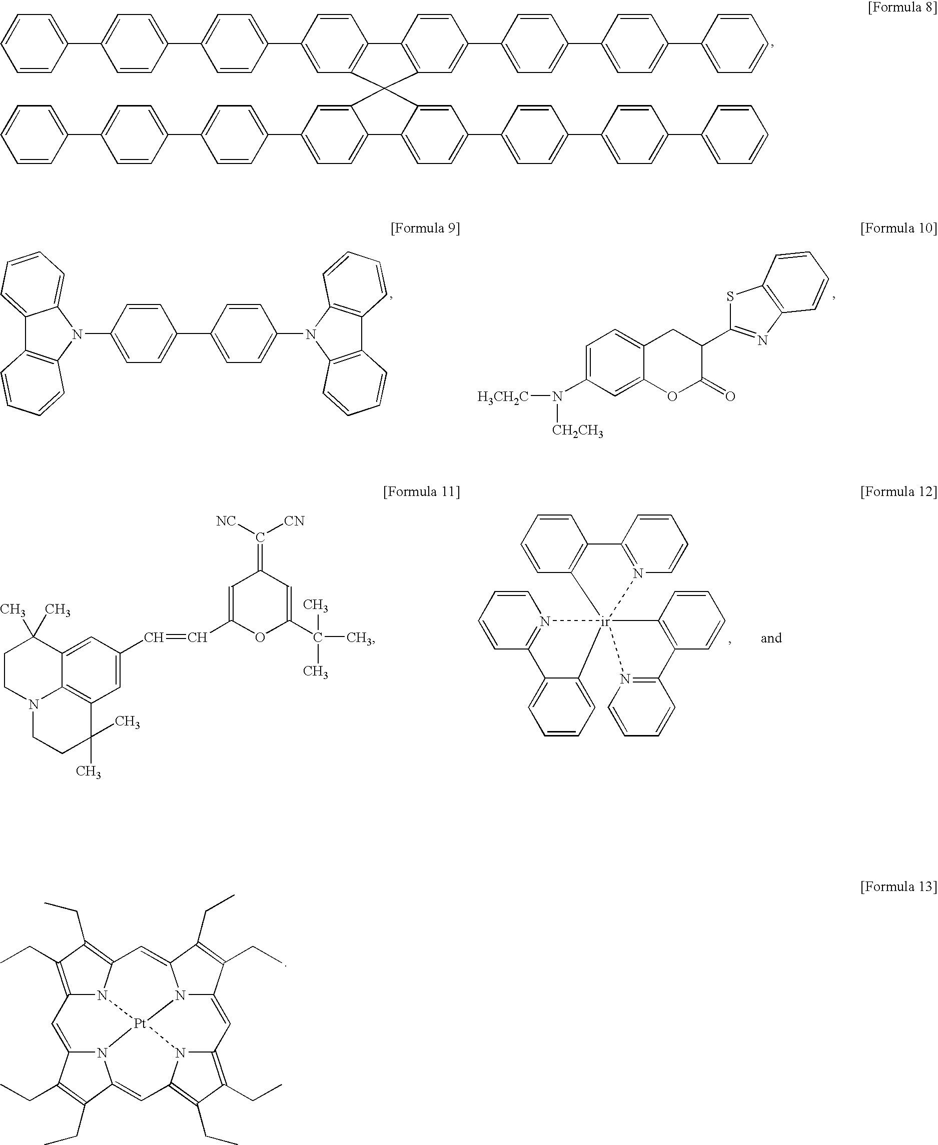

44. The organic EL display device according to claim 37, wherein the polymeric material is a hole transport material, and the small molecular organic material is a small molecular light emitting material.

45. The organic EL display device according to claim 44, wherein the hole transport material is a polymeric kind selected from a group consisting of polyaniline (PANI), poly ethylene dioxy thiospnene (PEDOT), carbozole, arylamine, perylene, and pyrrole-based polymers.

46. The organic EL display device according to claim 44, wherein the small molecular light emitting material is at least one selected from the group consisting of Formulas 1 to 13:

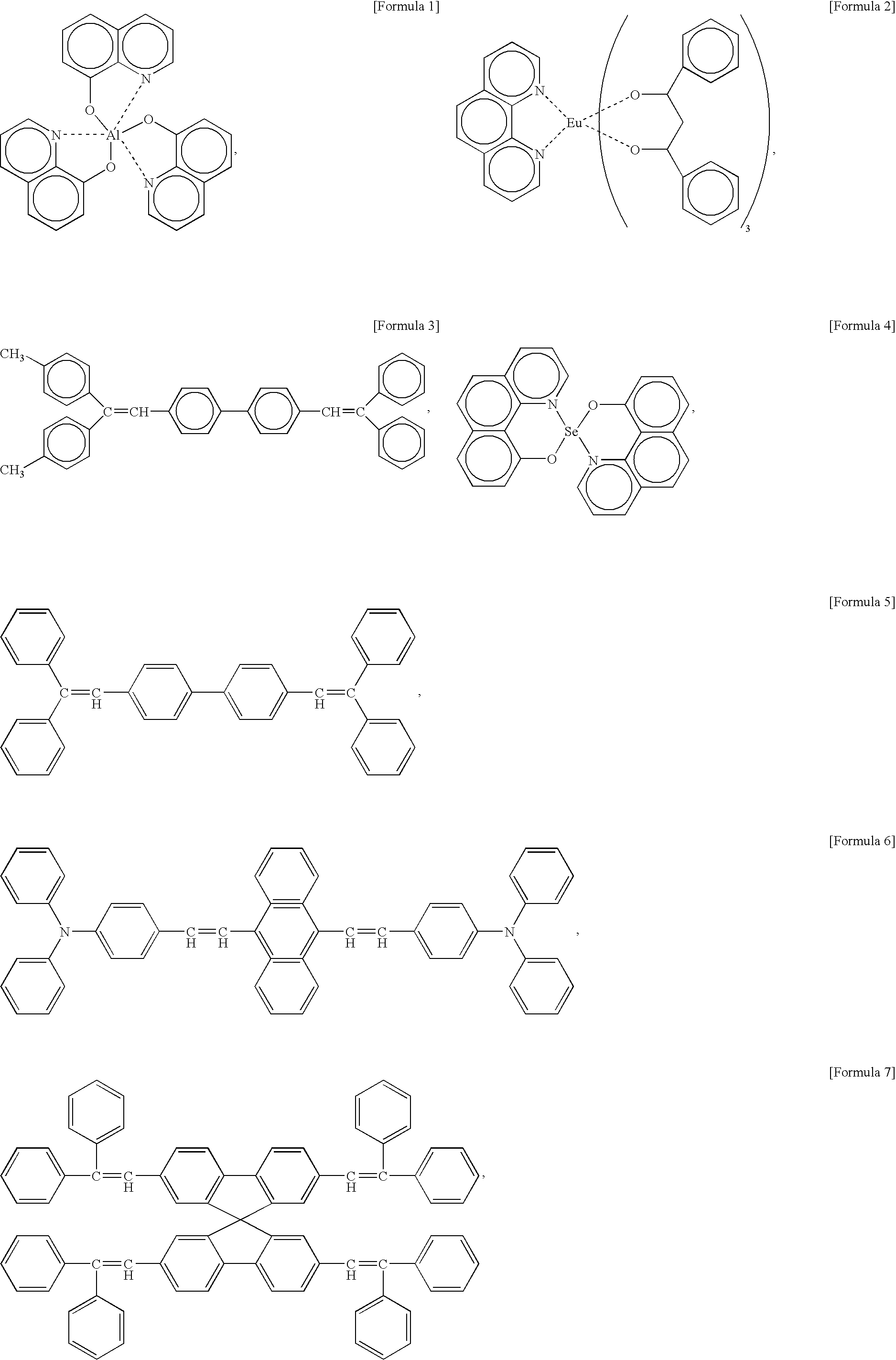

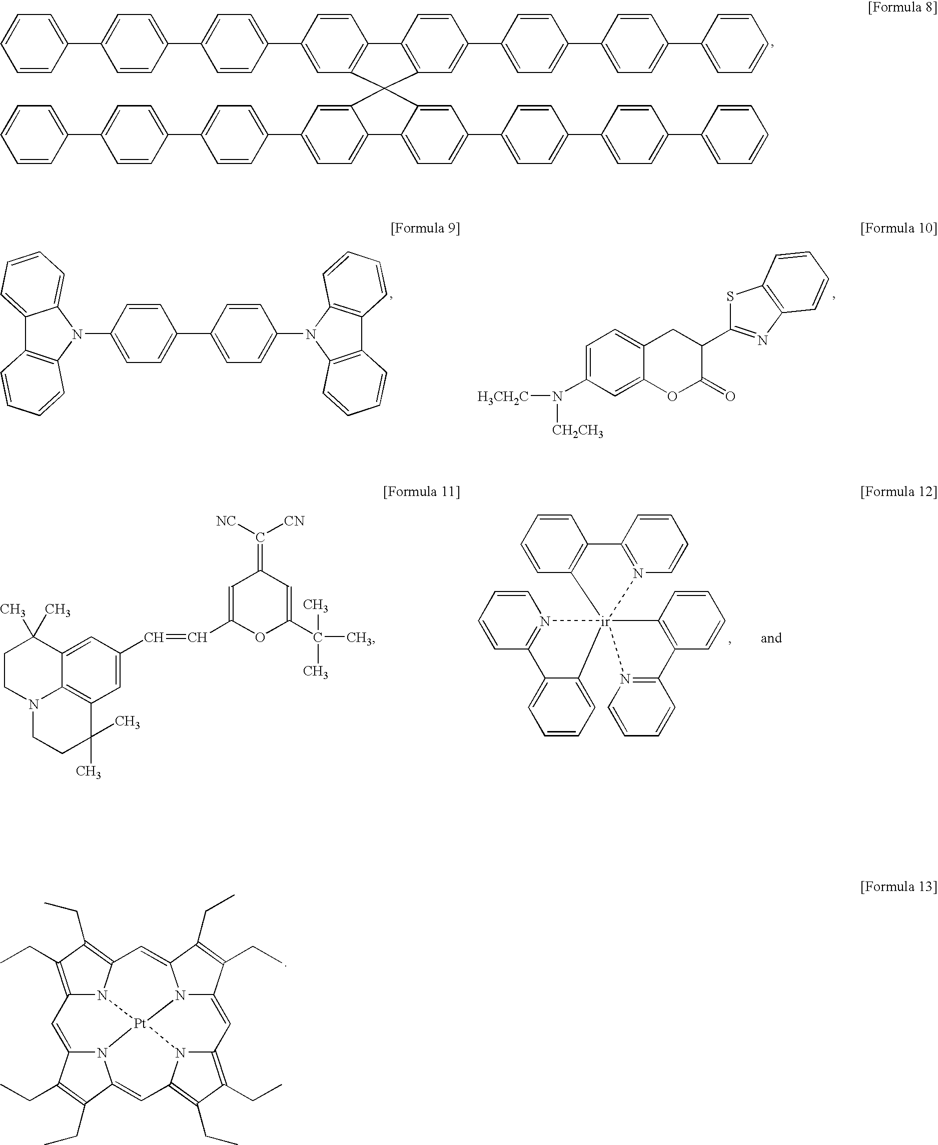

47. The organic EL display device according to claim 37, wherein the polymeric material is a polymeric light emitting material, and the small molecular organic material is a small molecular hole transport material.

48. The organic EL display device according to claim 47, wherein the polymeric light emitting material is any one of poly(9,9-dicoctyl fluorine)-based polymers and poly(p-phenylene vinylene)-based polymers.

49. The organic EL display device according to claim 47, wherein the small molecular hole transport material is a small molecular selected from the group consisting of Formulas 14 to 21:

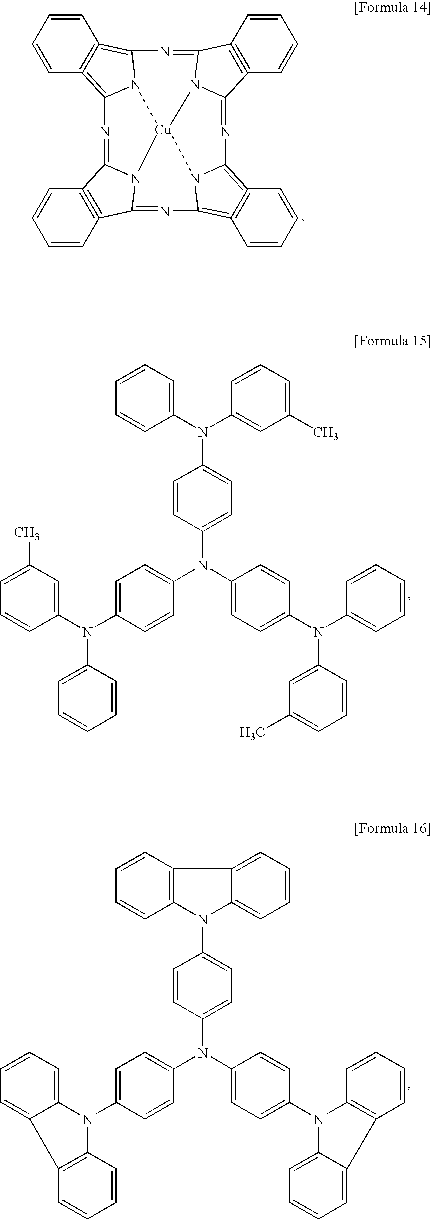

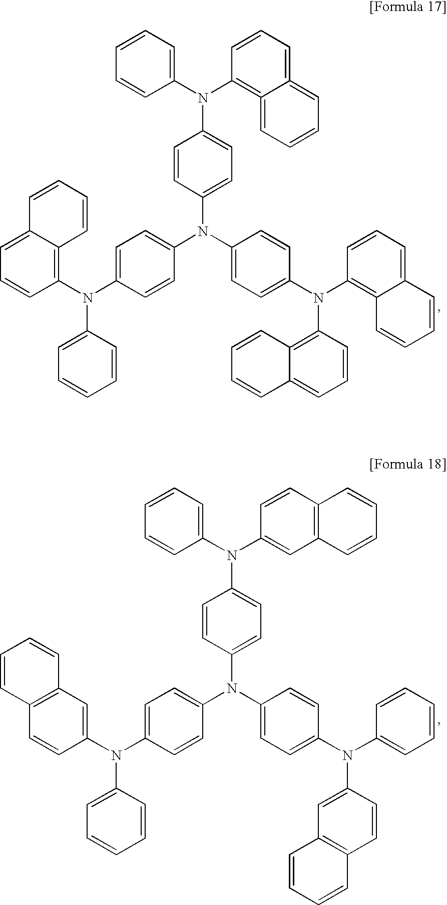

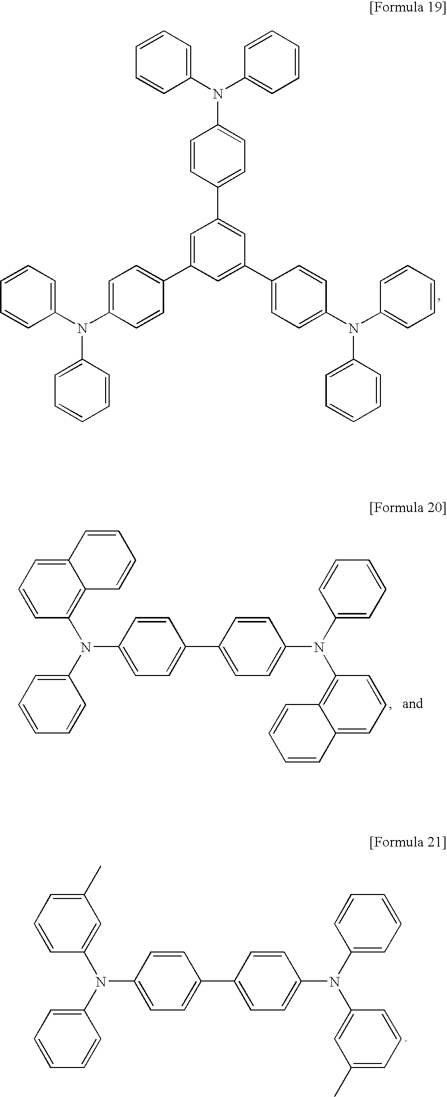

50. The organic EL display device according to claim 37, wherein the polymeric material is a polymeric light emitting material, and the small molecular organic material is a small molecular electron transport material.

51. The organic EL display device according to claim 50, wherein the polymeric light emitting material is any one of poly(9,9-dicoctyl fluorine)-based polymers and poly(p-phenylene vinylene)-based polymers.

52. The organic EL display device according to claim 50, wherein the small molecular electron transport material is one selected from a group consisting of bis(2-methyl-8-quinolinolato)(4-phenylphenolato)aluminum (BAlq), 2,9-dimethyl-4,7-diphenyl-1,10-phenanthroline (BCP), fluorocarbon (CFx), 3-phenyl-4-(1′-naphthyl)-5-phenyl-1,2,4-triazole (TAZ), s-TAZ, tris(8-quinolinolato)-aluminum (Alq3), Ga complex, 2-(4-biphenylyl)-5-(4-t-butylphenyl)-1,3,4-oxadiazole (PBD), 1,3,4-oxadizole derivative, or 1,2,4-traizole (TPA).

53. The organic EL display device according to claim 37, wherein the second organic layer has a thickness of 100 Å to 500 Å, and the first organic layer has a thickness of 150 Å to 400 Å.

54. The organic EL display device according to claim 37, further comprising:
at least one third organic layer.
